(19) United States
(12) Patent Application Publication
(10) Pub. No.: US 2022/0398895 A1
(43) Pub. Date: Dec. 15, 2022

(54) Methods, Apparatuses, Systems, Media, and Computer Devices for Processing Data

(71) Applicant: SENSETIME INTERNATIONAL PTE. LTD., Singapore (SG)

(72) Inventor: Xinxin Wang, Singapore (SG)

(21) Appl. No.: 17/363,873

(22) Filed: Jun. 30, 2021

Related U.S. Application Data
(63) Continuation of application No. PCT/IB2021/055659, filed on Jun. 25, 2021.

(30) Foreign Application Priority Data
Jun. 11, 2021 (SG) 10202106259P

(51) Int. Cl. G07F 17/32; G06K 9/00; H04N 7/18; H04L 29/08

(52) U.S. Cl. CPC G07F 17/3241; G06K 9/00744; H04N 7/183; H04L 67/025

(57) ABSTRACT

Provided are a method, apparatus and system for processing data, a medium and a computer device thereof. A first event corresponding to a video frame is determined by performing event determination for an analysis result of the video frame in a video frame sequence based on a pre-stored event determination logic, and then, a frame identifier of the video frame in the video frame sequence is acquired in a case that the first event is an erroneous determination, thereby accurately locating the video frame resulting in an erroneous determination event from the video frame sequence. Thus, the analysis result of the video frame is read from a message queue based on the frame identifier, and pushed. Therefore, a reason for an erroneous determination event is accurately analyzed out based on the analysis result of the target video frame.

### CROSS REFERENCE TO RELATED APPLICATION

This application is a continuation of International Application No. PCT/IB2021/055659 filed on Jun. 25, 2021, which claims priority to Singaporean Patent Application No. 10202106259P entitled “METHODS, APPARATUSES, SYSTEMS, MEDIA, AND COMPUTER DEVICES FOR PROCESSING DATA” and filed on Jun. 11, 2021, which is incorporated herein by reference in its entirety.

### TECHNICAL FIELD

The present disclosure relates to the field of computer vision technologies, and in particular to a method, an apparatus, a system a medium, and a computer device for processing data.

### BACKGROUND

In actual production and life, some events may occur, which often correspond to event occurrence conditions. For example, in a game scenario, in an event that a game participant operates a game prop, the game participant is required to obey a game rule, for example, a timing of operating a specific game prop needs to conform to the game rule. When the game participant operates the specific game prop in a timing does not conform to the game rule, it is considered that an event of cheating or misoperation of the game participant occurs. During sports activities of an athlete, the actions performed by the athlete need to reach a certain standard. If the actions of the athlete do not reach the corresponding standard, it is considered that an event of substandard sports occurs. Some event determination logics may be designed based on event occurrence conditions to automatically determine these events. However, there may also be erroneous determination cases that need to be located for further analysis.

### SUMMARY

The present disclosure provides a method, apparatus and system for processing data, a medium, and a computer device to locate an erroneous determination event.

According to a first aspect of examples of the present disclosure, there is provided a method of processing data. The method includes: acquiring an analysis result obtained by analyzing a video frame in a video frame sequence; performing event determination for the analysis result of the video frame based on a pre-stored event determination logic, to determine a first event corresponding to the video frame; in response to that the first event is an erroneous determination, taking the video frame corresponding to the first event as a target video frame and acquiring a frame identifier of the target video frame in the video frame sequence; reading the analysis result of the target video frame from a message queue based on the frame identifier, where the message queue is used to store an analysis result of each video frame in the video frame sequence; and pushing the analysis result of the target video frame.

In some examples, the method further includes: sending information of the first event to a displaying unit, so that the displaying unit displays the information of the first event.

In some examples, the information of the first event includes the frame identifier of the video frame corresponding to the first event in the video frame sequence.

In some examples, acquiring the analysis result obtained by analyzing the video frame in the video frame sequence includes: acquiring the video frame sequence transmitted back by a remote terminal; and obtaining the analysis result of the video frame by analyzing the video frame in the video frame sequence.

In some examples, acquiring the video frame sequence transmitted back by the remote terminal includes: copying the video frame sequence into a local test environment; and switching an input source of video frame sequence to the video frame sequence copied into the local test environment.

In some examples, acquiring the analysis result obtained by analyzing the video frame in the video frame sequence includes: acquiring text information carrying the analysis result of the video frame in the video frame sequence from a remote terminal, where the text information is generated by the remote terminal analyzing the video frame in the video frame sequence.

In some examples, the analysis result of the video frame is issued to a preset message queue with a designated topic; acquiring the analysis result obtained by analyzing the video frame in the video frame sequence includes: acquiring the analysis result of the video frame by subscribing to the designated topic.

In some examples, the information of the first event includes the frame identifier of the video frame corresponding to the first event in the video frame sequence; acquiring the analysis result of the video frame by subscribing to the designated topic includes: in response to receiving an instruction for invoking the analysis result of the target video frame, determining the topic corresponding to the analysis result of the target video frame according to the frame identifier of the target video frame; and extracting the analysis result of the target video frame from the message queue according to the topic corresponding to the analysis result of the target video frame.

In some examples, a number of video frames in the video frame sequence is greater than 1, and video frames in the video frame sequence are captured respectively by at least two video capture apparatuses with different views around a target region; acquiring the analysis result obtained by analyzing the video frame in the video frame sequence includes: performing synchronization for each single-view video frame in a plurality of single-view video frames captured respectively by the at least two video capture apparatuses; acquiring an initial analysis result of each single-view video frame; and obtaining an analysis result of a plurality of synchronized single-view video frames by fusing the initial analysis results of the plurality of synchronized single-view video frames.

In some examples, the video frame sequence is obtained by performing video capture for the target region; acquiring the analysis result obtained by analyzing the video frame in the video frame sequence includes: acquiring the analysis result obtained by analyzing the video frame in the video frame sequence in a case that the remote terminal determines that an event unsatisfying a preset condition occurs in the target region.

In some examples, the target video frame further includes other video frames spaced apart from the video frame by a number of frames smaller than a preset frame number.

In some examples, in a case that the first event is inconsistent with a second event determined by a user based on the video frame, the first event is determined as erroneous determination.

According to a second aspect of examples of the present disclosure, there is provided an apparatus for processing data. The apparatus includes: a first acquiring module, configured to acquire an analysis result obtained by analyzing a video frame in a video frame sequence; an event determining module, configured to perform event determination for the analysis result of the video frame based on a pre-stored event determination logic, to determine a first event corresponding to the video frame; a second acquiring module, configured to in response to that the first event is an erroneous determination, take the video frame corresponding to the first event as a target video frame and acquire a frame identifier of the target video frame in the video frame sequence; a reading module, configured to read the analysis result of the target video frame from a message queue based on the frame identifier, where the message queue is used to store an analysis result of each video frame in the video frame sequence; and a pushing module, configured to push the analysis result of the target video frame.

In some examples, the apparatus further includes: a sending module, configured to send information of the first event to a displaying unit, so that the displaying unit displays the information of the first event.

In some examples, the information of the first event includes the frame identifier of the video frame corresponding to the first event in the video frame sequence.

In some examples, the first acquiring module includes: a first acquiring unit, configured to acquire the video frame sequence transmitted back by a remote terminal; and an analyzing unit, configured to obtain the analysis result of the video frame by analyzing the video frame in the video frame sequence.

In some examples, the first acquiring unit includes: a copying sub-unit, configured to copy the video frame sequence into a local test environment; and a switching sub-unit, configured to switch an input source of the video frame sequence to the video frame sequence copied into the local test environment.

In some examples, the first acquiring module includes: a second acquiring unit, configured to acquire text information carrying the analysis result of the video frame in the video frame sequence from the remote terminal, where the text information is generated by the remote terminal by analyzing the video frame in the video frame sequence.

In some examples, the analysis result of the video frame is issued to a preset message queue with a designated topic; the first acquiring module is configured to acquire the analysis result of the video frame by subscribing to the designated topic.

In some examples, the information of the first event includes the frame identifier of the video frame corresponding to the first event in the video frame sequence; the first acquiring module includes: a determining unit, configured to determine the topic corresponding to the analysis result of the target video frame according to the frame identifier of the target video frame in response to receiving an instruction for invoking the analysis result of the target video frame; and an extracting unit, configured to extract the analysis result of the target video frame from the message queue according to the topic corresponding to the analysis result of the target video frame.

In some examples, a number of video frames in the video frame sequence is greater than 1, and video frames in the video frame sequence are captured respectively by at least two video capture apparatuses with different views around a target region; the first acquiring module includes: a synchronization processing module, configured to perform synchronization for each single-view video frame in a plurality of single-view video frames collected respectively by the at least two video capture apparatuses; an initial analysis result acquiring module, configured to acquire an initial analysis result of each single-view video frame; and a fusing module, configured to obtain an analysis result of a plurality of synchronized single-view video frames by fusing the initial analysis results of the plurality of synchronized single-view video frames.

In some examples, the video frame sequence is obtained by performing video capture for the target region; the first acquiring module is configured to acquire the analysis result obtained by analyzing the video frame in the video frame sequence in a case that the remote terminal determines that an event unsatisfying a preset condition occurs in the target region.

In some examples, one or more other video frames spaced apart from the video frame corresponding to the first event by a number of frames smaller than a preset frame number in the video frame sequence are also taken as the target video frame.

In some examples, in a case that the first event is inconsistent with a second event determined by a user based on the video frame, the first event is determined as erroneous determination.

According to a third aspect of examples of the present disclosure, there is provided a system for processing data. The system includes: a video capture apparatus disposed around a target region to collect a video frame sequence of the target region; and a processing unit in communication with the video capture apparatus, configured to perform the method according to any example of the present disclosure.

According to a fourth aspect of examples of the present disclosure, there is provided a computer readable storage medium storing a computer program thereon. The program is executed by a processor to implement the method according to any example of the present disclosure.

According to a fifth aspect of examples of the present disclosure, there is provided a computer device including a memory, a processor and a computer program that is stored on the memory and operable on the processor. The computer program is executed by the processor to implement the method according to any example of the present disclosure.

In the examples of the present disclosure, the first event corresponding to the video frame is determined by performing event determination for the analysis result of the video frame in the video frame sequence based on the pre-stored event determination logic, and then, the frame identifier of the video frame in the video frame sequence is acquired in response to that the first event is an erroneous determination. In this way, the video frame resulting in an erroneous determination event is located accurately from the video frame sequence, and the analysis result of the video frame is further read from the message queue based on the frame identifier, and then pushed. Therefore, a reason for an erroneous determination event can be accurately analyzed out based on the analysis result of the target video frame.

It is to be understood that the above general descriptions and the subsequent detailed descriptions are merely exemplary and explanatory, and are not intended to limit the present disclosure.

### BRIEF DESCRIPTION OF THE DRAWINGS

The accompanying drawings, which are incorporated in and constitute a part of the present description, illustrate examples consistent with the present disclosure and serve to explain the technical solutions of the present disclosure together with the description.

FIG. 1 is a flowchart of a method of processing data according to one or more examples of the present disclosure.

FIG. 2A and FIG. 2B are schematic diagrams of a data transmission process according to one or more examples of the present disclosure respectively.

FIG. 3 is a schematic diagram of a message queue according to one or more examples of the present disclosure.

FIG. 4 is a schematic diagram of a fusion and synchronization process according to one or more examples of the present disclosure.

FIG. 5 is a schematic diagram of a display interface according to one or more examples of the present disclosure.

FIG. 6 is a schematic diagram of a network architecture according to one or more examples of the present disclosure.

FIG. 7A and FIG. 7B are flowcharts of overall flows of data processing according to one or more examples of the present disclosure.

FIG. 8 is a block diagram of an apparatus for processing data according to one or more examples of the present disclosure.

FIG. 9 is a schematic diagram of a system for processing data according to one or more examples of the present disclosure.

FIG. 10 is a structural diagram of a computer device according to one or more examples of the present disclosure.

### DETAILED DESCRIPTION OF THE EMBODIMENTS

Examples will be described in detail herein, with the illustrations thereof represented in the drawings. When the following descriptions involve the drawings, like numerals in different drawings refer to like or similar elements unless otherwise indicated. Implementations described in the following examples do not represent all implementations consistent with the present disclosure. Rather, they are merely examples of apparatuses and methods consistent with some aspects of the present disclosure as detailed in the appended claims.

Terms used in the present disclosure are for the purpose of describing particular examples only, and are not intended to limit the present disclosure. Terms “a”, “the” and “said” in their singular forms in the present disclosure and the appended claims are also intended to include plurality, unless clearly indicated otherwise in the context. It should also be understood that the term “and/or” as used herein refers to and includes any or all possible combinations of one or more of the associated listed items. In addition, the term “at least one” herein refers to any one or any combination of at least two in a plurality of items.

It is to be understood that although different information may be described using terms such as first, second, third, etc. in the present disclosure, the information should not be limited to these terms. These terms are used only to distinguish the same type of information from each other. For example, the first information may also be referred to as the second information without departing from the scope of the present disclosure, and similarly, the second information may also be referred to as the first information. Depending on the context, the word “if” as used herein may be interpreted as “when” or “as” or “determining in response to”.

To help persons skilled in the art to understand the technical solutions in the examples of the present disclosure better and make the above objects, features and advantages of the examples of the present disclosure clearer, the technical solutions in the examples of the present disclosure will be further described in detail below in combination with the drawings.

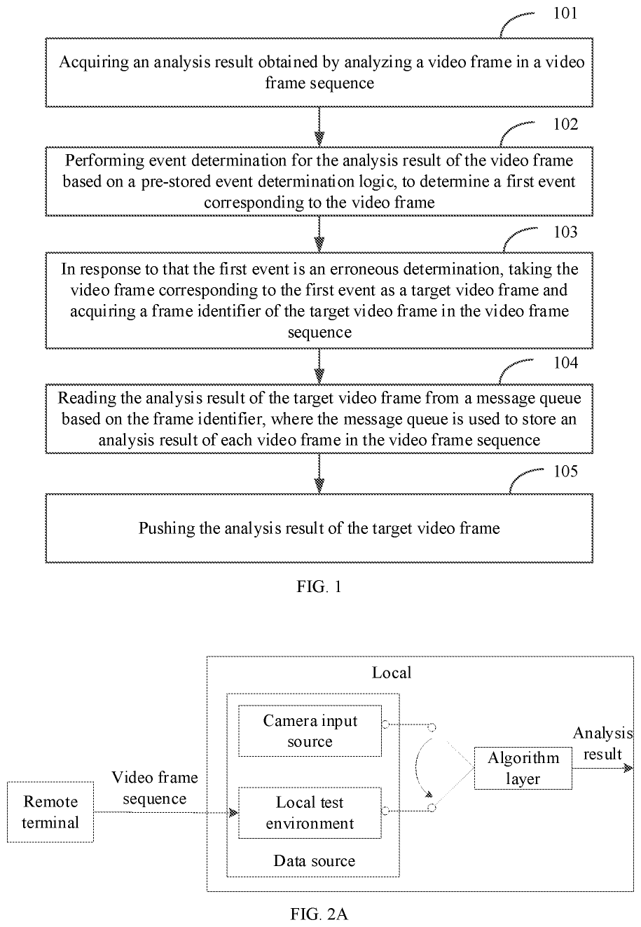

As shown in FIG. 1, an example of the present disclosure provides a method of processing data. The method includes the following steps.

At step 101, acquiring an analysis result obtained by analyzing a video frame in a video frame sequence.

At step 102, performing event determination for the analysis result of the video frame based on a pre-stored event determination logic, to determine a first event corresponding to the video frame.

At step 103, in response to that the first event is an erroneous determination, taking the video frame corresponding to the first event as a target video frame and acquiring a frame identifier of the target video frame in the video frame sequence.

At step 104, reading the analysis result of the target video frame from a message queue based on the frame identifier, where the message queue is used to store an analysis result of each video frame in the video frame sequence.

At step 105, pushing the analysis result of the target video frame.

At step 101, the video frame sequence may include one or more video frames arranged in the order of time, and the time may be a time of collecting the video frame. The video frame sequence may include part video frames or all video frames of a video The video may be obtained by a video capture apparatus (e.g., a camera) disposed around a target region by performing video capture for the target region, and then, the video frame sequence is formed by selecting video frames from the captured video according to a certain frame selection strategy.

The analysis result of one video frame may include a detection result and/or an identification result obtained by performing target object detection and/or identification for the video frame. The detection result may be used to indicate whether the video frame includes information of a target object, i.e. position information, dimension information and number information and the like of the target object, and the identification result may include category information of the target object in the video frame. Optionally, the analysis result may include an association result obtained by analyzing an association relationship between target objects in the video frame.

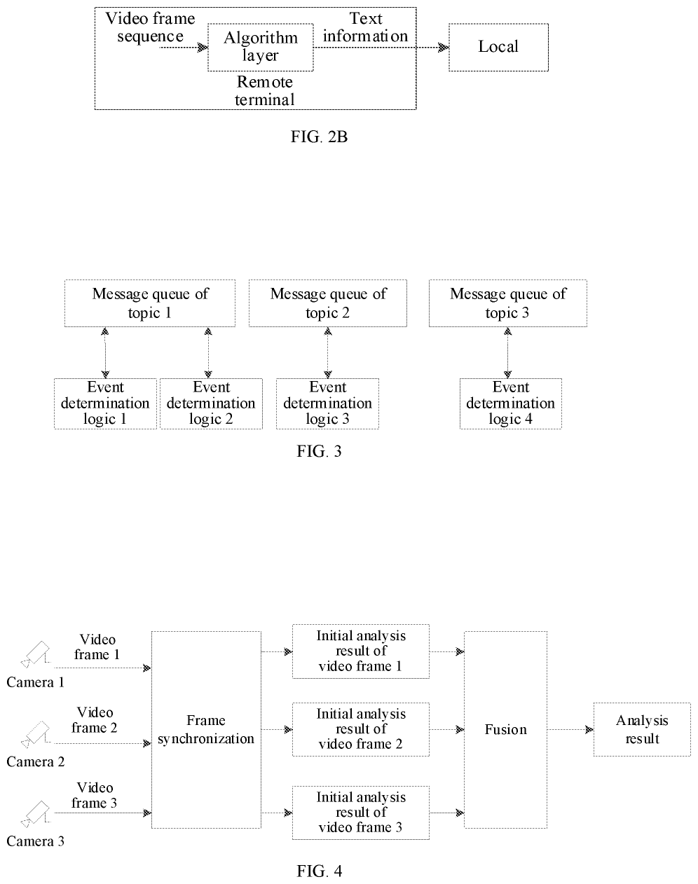

The video frame sequence of the target region transmitted back by a remote terminal may be acquired and then the analysis result of the video frame is obtained by locally analyzing the video frame in the video frame sequence. As shown in FIG. 2A, in a case of locally analyzing the video frame in the video frame sequence, the video frame sequence may be copied from the remote terminal into a local test environment, and then, an input source of the video frame sequence is switched from another data source (e.g., a camera input source) to the video frame sequence copied into the local test environment, where the camera input source is used to acquire a video frame sequence captured by a local camera. The remote terminal may be a terminal for collecting the video frame sequence. For example, after collecting the video frame sequence, the video capture apparatus disposed around the target region directly transmits the video frame sequence to the local. Optionally, the remote terminal may also be another terminal other than the terminal for collecting the video frame sequence. For example, after collecting the video frame sequence, the video capture apparatus disposed around the target region firstly transmits the video frame sequence to another terminal which then transmits the video frame sequence to the local.

As shown in FIG. 2B, the remote terminal may also analyze the video frame in the video frame sequence to generate text information carrying the analysis result of the video frame in the video frame sequence, and then transmits the text information back to the local. In this way, only the text information needs to be transmitted between the remote terminal and the local without transmitting the video frame itself, thereby effectively reducing data transmission amount and improving data transmission efficiency. The text information may be transmitted back to the local in real time when the remote terminal analyzes the video frame, or may be firstly cached by the remote terminal and then transmitted back to the local when certain conditions are satisfied. The text information may be a text of private protocol format to improve safety of data transmission.

The analysis result of the video frame may be stored in a message queue, and read from the message queue when necessary. For example, the analysis result of the video frame is issued to a preset message queue with a designated topic so that a receiving terminal subscribing to the topic may acquire the analysis result of the video frame from the message queue. To improve the acquisition efficiency of the analysis result, each topic may correspond to one or more event determination logics. As shown in FIG. 3, a message queue of a topic 1 corresponds to an event determination logic 1 and an event determination logic 2, so that the event determination logic 1 and the event determination logic 2 may acquire the analysis result of the video frame from the message queue of the topic 1; a message queue of a topic 2 corresponds to an event determination logic 3, so that the event determination logic 3 may acquire the analysis result of the video frame from the message queue of the topic 2; a message queue of a topic 3 corresponds to an event determination logic 4, so that the event determination logic 4 may acquire the analysis result of the video frame from the message queue of the topic 3.

In some examples, a number of video frames in the video frame sequence is greater than 1, and video frames in the video frame sequence are captured respectively by at least two video capture apparatuses with different views around the target region. In this case, synchronization may be performed for each single-view video frame in a plurality of single-view video frames captured respectively by the at least two video capture apparatuses; an initial analysis result of each single-view video frame may be acquired; an analysis result of a plurality of synchronized single-view video frames is obtained by fusing the initial analysis results of a plurality of synchronized single-view video frames.

As shown in FIG. 4, three cameras may be disposed around the target region, and each camera is disposed at a different position around the target region respectively to collect a video frame of the target region at a different view. For example, a camera 1 may be disposed exactly above the target region to collect a video frame of the target region at a bird view, and a camera 2 and a camera 3 may be disposed at both sides of the target region respectively to collect video frames of the target region at a side view. Frame synchronization may be performed for a video frame 1 captured by the camera 1, a video frame 2 captured by the camera 2 and a video frame 3 captured by the camera 3, where the video frame 1, the video frame 2 and the video frame 3 may be video frames captured at a same moment. Further, an initial analysis result of the video frame 1, an initial analysis result of the video frame 2 and an initial analysis result of the video frame 3 may also be acquired respectively, and the initial analysis results of the video frame 2 and the video frame 3 may be fused into the initial analysis result of the video frame 1 to obtain the analysis result of the video frame 1. The step of acquiring the initial analysis result of the video frame may be performed before or after the frame synchronization, or performed during the frame synchronization, which is not limited in the present disclosure.

For example, an initial analysis result acquired by analyzing the video frame of a moment t1 captured by the camera above the target region includes a position of a stacked object in the target region at the moment t1, an initial analysis result acquired by analyzing the video frame of the moment t1 captured by the camera at the side of the target region includes the number of stacked objects in the target region at the moment t1, and thus the number of stacked objects at the position at the moment t1 may be obtained by fusing the initial analysis results of the video frames of the moment t1 captured by the two cameras.

At step 102, event determination may be performed for the analysis result of the video frame based on the pre-stored event determination logic. The event determination logic may include a placement position determination logic, a placement order determination logic, a placement time determination logic, and a target-object-number determination logic for one or more target objects in a video frame, and the like. For example, whether the placement position of a target object in the video frame satisfies a first preset condition is determined based on the position information of the target object in the video frame; whether the placement order of target objects in at least two video frames satisfies a second preset condition is determined based on the position information of the target objects in the at least two video frames; whether the placement time of a target object in the video frame satisfies a third preset condition is determined based on a time stamp of the video frame; whether the number of detected target objects in the video frame satisfies a fourth preset condition is determined. In addition to the above determination logics, the event determination logic in an example of the present disclosure may further include other determination logics, and the determination manner corresponding to each determination logic may also be another determination manner, which is not described in detail herein.

At step 103, if the first event is an erroneous determination, it is determined that the video frame corresponding to the first event is the target video frame. Optionally, the process of determining whether the first event is an erroneous determination may be manually performed. For example, a user may watch the video frame and perform event determination to determine an occurring event is a second event, and then compare the first event with the second event. If the first event is inconsistent with the second event, the user determines that the first event is an erroneous determination. By watching the video frame, the user can intuitively and accurately determine the actually occurring second event based on the video frame, and take the second event as a ground truth to determine whether the first event identified based on an algorithm is an erroneous determination, thereby improving an accuracy of determining whether the event is an erroneous determination. During comparison, the user may read the cached video frames one by one, thereby avoiding the case that it is difficult to find the second event in the video frame in time due to too fast refreshing frequency of the video frames captured in real time.

Optionally, the process of determining the target video frame may also be automatically implemented. For example, the second event determined by another terminal based on the video frame may be acquired. If the second event determined by the another terminal is inconsistent with the first event, it is locally determined that the first event is an erroneous determination. The another terminal performs event determination, based on the pre-stored event determination logic, for the analysis result obtained by analyzing a reference video frame to determine the second event corresponding to the reference video frame. The reference video frame is synchronized with the video frame, and satisfies at least one of the following conditions: a resolution of the reference video frame is higher than that of the video frame; the event determination logic is used to determine events occurring to one or more target objects in the video frame and the reference video frame, and an integrity of the target objects in the reference video frame is higher than that of the target object in the video frame; an accuracy of an analysis algorithm for analyzing the reference video frame is higher than that of an analysis algorithm for analyzing the video frame.

When the video frame is the target video frame, a frame identifier of the target video frame may be acquired. The frame identifier may be a frame number of the target video frame, or a time stamp of the target video frame, or other information for distinguishing the video frame from other video frames in the video frame sequence. The target video frame with an erroneous determination event may be accurately located based on the frame identifier.

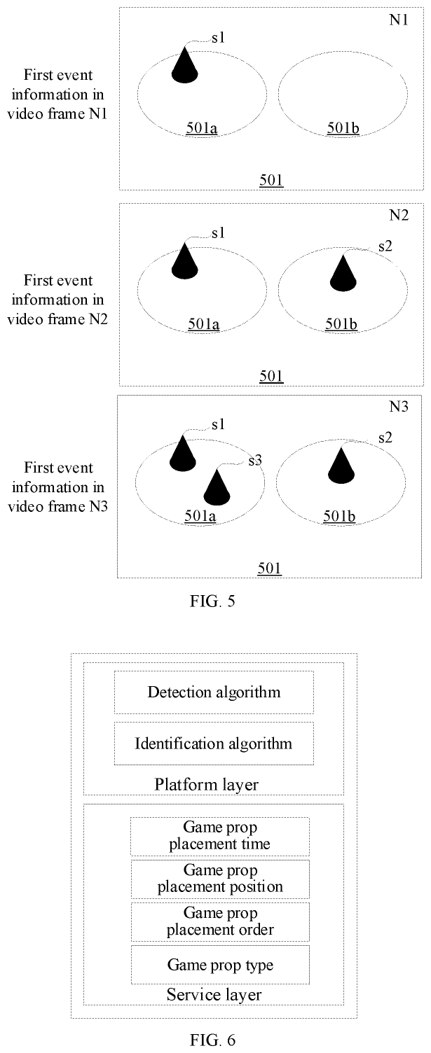

To facilitate determining whether the first event is an erroneous determination, information of the first event may be sent to a displaying unit, so that the displaying unit displays the information of the first event to help the user to perform determination more intuitively. As shown in FIG. 5, event determination is performed for an analysis result of a video frame N1 based on a pre-stored event determination logic, and the determined first event is that a game prop s1 is placed in a sub-region 501a of a target region 501, and thus, the game prop s1 may be placed in the sub-region 501a on the displaying unit. Further, coordinates of the game prop in the sub-region 501a may also be determined to help the displaying unit to display more accurate information. Similarly, event determination is performed for an analysis result of a video frame N2 based on the pre-stored event determination logic, and the determined first event is that a game prop s2 is placed in a sub-region 501b of the target region 501; event determination is performed for an analysis result of a video frame N3 based on the pre-stored event determination logic, and the determined first event is that a game prop s3 is placed in the sub-region 501a of the target region 501. Information of the first event corresponding to the video frame N2 and information of the first event corresponding to the video frame N3 may be correspondingly displayed on a display interface.

Further, the first event may also be jointly determined based on a plurality of video frames (such as video frames N1, N2 and N3 in FIG. 5), and the first event may be an order in which the game props are placed in the sub-region 501a and the sub-region 501b. If video frame N1 is captured before video frame N2 and video frame N2 is captured before video frame N3, it may be determined that the game props are placed in the following order: one game prop is firstly placed in the sub-region 501a, and then, another game prop is placed in the sub-region 501b, and finally, yet another game prop is placed in the sub-region 501a. The order in which the game props are placed may be determined by sequentially displaying the information of the first events corresponding to the video frames N1, N2 and N3 respectively.

Further, the information of the first event includes the frame identifier of the video frame corresponding to the first event in the video frame sequence. For example, in the example shown in FIG. 5, the frame numbers N1, N2 or N3 of the video frames may be displayed on the display interface respectively. Persons skilled in the art may understand that the frame identifier may also be displayed at another position of the display interface in addition to the position shown in the drawing, which is not limited in the present disclosure.

At step 104, the analysis result of the target video frame may be read from the message queue based on the frame identifier. In a case of publishing the analysis result of the video frame with a designated topic in a preset message queue, the analysis result of the video frame may be acquired by subscribing to the designated topic.

In response to receiving an instruction for invoking the analysis result of the target video frame, the topic corresponding to the analysis result of the target video frame is determined based on the frame identifier of the target video frame; the analysis result of the target video frame is extracted from the message queue based on the topic corresponding to the analysis result of the target video frame. The instruction for invoking the analysis result of the target video frame may be input by the user by clicking a designated control on the display interface, or inputting the frame identifier of the target video frame, or the like, and the instruction may include the frame identifier of the video frame. The analysis result of the video frame may further include the frame identifier of the video frame. The analysis result of the target video frame may be acquired based on the frame identifier in the instruction and the frame identifier in the analysis result of the video frame.

At step 105, the analysis result of the target video frame may be pushed to the display interface for viewing by the user. By analyzing the analysis result, the user may determine whether the erroneous determination of the first event corresponding to the target video frame is caused by the erroneous detection and identification of the target video frame or the event determination logic.

In some examples, the video frame sequence is obtained by performing video capture for the target region; the analysis result may be obtained by the remote terminal by analyzing the captured video frame in the video frame sequence, and a third event may be determined based on the analysis result of the video frame. In a case that the remote terminal determines that an event unsatisfying a preset condition occurs in the target region, the analysis result obtained by analyzing the video frame in the video frame sequence is acquired. In an actual application, it is often only required to determine whether a determination result of the event determined as unsatisfying the preset condition is correct. For example, it is required to verify whether a game participant indeed has a non-compliant operation only when it is determined that the game participant performs non-compliant operation during the game. For another example, it is required to verify whether a vehicle indeed has a non-compliant action only when it is determined that the vehicle acts non-compliantly. In this example, the remote terminal determines whether an event unsatisfying a preset condition occurs in the target region to screen out the cases requiring verification for event determination results. Thus, it is not required to analyze all video frames.

The event unsatisfying the preset condition that occurs in the target region may be a third event unsatisfying the preset condition that is determined by the remote terminal based on analysis results of any one or more video frames in the video frame sequence. For example, based on the analysis result of a video frame, the remote terminal determines that the placement position of the game prop is not in a placeable region of the game prop. For another example, based on the analysis results of a plurality of video frames, the remote terminal determines that the placement order of game props does not conform to a preset order. In this case, the operation of step 101 may be triggered to determine whether a determination result that the remote terminal determines that an event unsatisfying the preset condition occurs in the target region is correct.

In some examples, one or more other video frames spaced apart from the video frame corresponding to the first event by a number of frames smaller than a preset frame number in the video frame sequence are also taken as the target video frame. For example, if the target video frame is the i^{th} video frame in the video frame sequence, the i−1^{th}, i−2^{th}, i−k^{th} video frame in the video frame sequence and/or the i+1^{th}, i+2^{th}, i+k^{th} video frame in the video frame sequence may be all determined as target video frames, where k is a positive integer.

The method according to an example of the present disclosure may be applied to a network architecture shown in FIG. 6. The network architecture includes two layers, i.e., a platform layer and a service layer. The platform layer is used to acquire an analysis result obtained by analyzing a video frame in a video frame sequence and publish the analysis result with a designated topic in a message queue. The platform layer may include at least one of a detection algorithm and an identification algorithm. The service layer is used to perform event determination for the analysis result of the video frame based on a pre-stored event determination logic. The event may include but not limited to at least one of the followings: an event indicating whether a game prop placement time satisfies a preset condition, an event indicating whether a game prop placement position satisfies a preset condition, an event indicating whether a game prop placement order satisfies a preset condition, and an event indicating whether a game prop type satisfies a preset condition, and the like.

The solutions of the examples of the present disclosure may be applied to a game place scenario. In this scenario, it is very difficult to build a real test environment having gaming tables, proprietary game coins, proprietary playing cards, Singapore dollars, markers, and the like. During the test, it will be very difficult to find a problem if it is found that system does not perform as well as expected. To solve this problem, two methods are proposed to perform troubleshooting. Specifically, any of the following methods may be adopted.

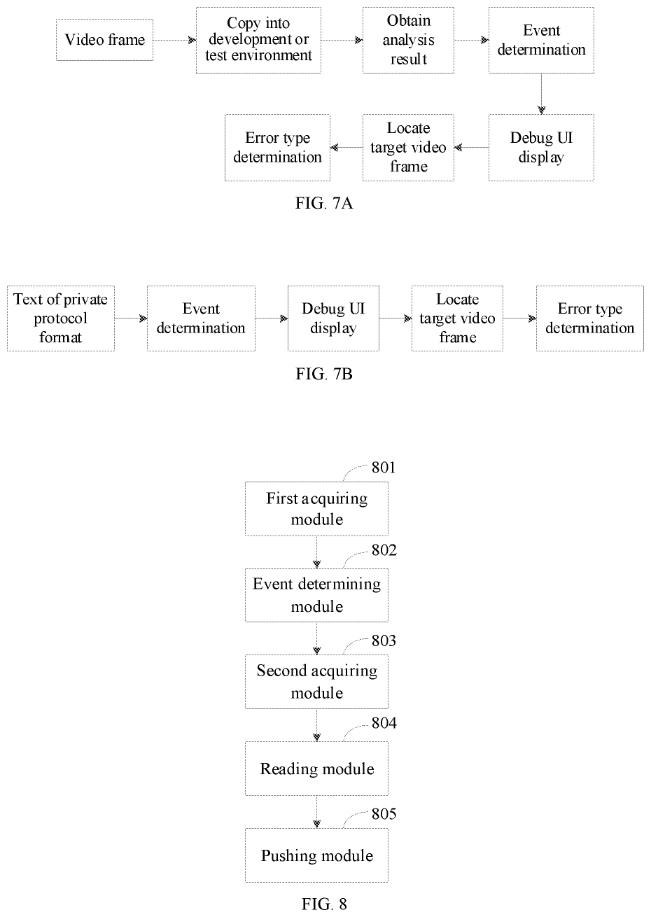

As shown in FIG. 7A, the first method includes the following steps.

At step (1), the problem is reproduced by repeating operations of a game master and a player in the game in which the problem just occurs in a test site, and a video is recorded through the platform layer.

At step (2), the recorded video is copied into a development or test environment, and a data input source is switched from a camera to the local video through the platform layer in the development or test environment.

At step (3), after the video is read, the analysis result of the video frame is sent to the platform layer based on the algorithm, and the platform layer pushes data subjected to camera fusion and frame synchronization to a designated topic of a message queue (MQ).

At step (4), the service layer obtains the analysis result obtained by the platform layer by processing the problem-reproducing video from the MQ, performs event determination, and pushes information of the first event determined after event determination to a displaying unit (hereafter also referred to as a debug user interface and a debug UI for short).

At step (5), the debug UI displays the information of the first event on a web page by using a graphical interface, and a frame number of the currently processed video frame is displayed on the web page.

At step (6), the developers may find out which frame or frames have the problem by observing the debug UI.

At step (7), the analysis result of the corresponding target video frame is obtained in the designated topic of the MQ based on the frame number.

At step (8), whether it is an error of detection and identification association based on algorithm or an error of processing of the service layer is analyzed by comparing with the target video frame.

As shown in FIG. 7B, the second method includes the following steps.

At step (1), the problem is reproduced by repeating operations of the game master and the player in the game in which the problem just occurs in the test site, and the platform layer may write a message sent by the platform layer to the specific topic of the MQ for consumption by the service layer in the game to which the problem occurs into a text of private protocol format.

At step (2), the text of private protocol format is copied into the development or test environment, and text data is read by starting a analysis program in the development or test environment and sent to the designated topic of the local MQ for consumption by the service layer.

At step (3), in this way, the algorithm and the platform layer are skipped, and the service layer may take the data obtained by the platform layer by processing the problem-reproducing video from the MQ for processing, and push a processing result to the debug UI.

At step (4), the debug UI displays the information of the first event on the web page with a graphical interface, and the frame number of the currently processed video frame is displayed on the web page.

At step (5), the developers find out which frame or frames have the problem by observing the debug UI.

At step (6), the analysis result of the corresponding target video frame is obtained in the designated topic of the MQ based on the frame number.

At step (7), whether it is an error of detection and identification association based on algorithm or an error of processing of the service layer is analyzed by comparing with the target video frame.

Persons skilled in the art may understand that in the above methods of specific examples, the drafting order of various steps does not mean a strict execution order that constitutes any limitation to the implementation processes, and the specific execution order of each step may be determined by its functions and possible internal logics.

As shown in FIG. 8, the present disclosure further provides an apparatus for processing data. The apparatus includes:

a first acquiring module 801, configured to acquire an analysis result obtained by analyzing a video frame in a video frame sequence;

an event determining module 802, configured to perform event determination for the analysis result of the video frame based on a pre-stored event determination logic, to determine a first event corresponding to the video frame;

a second acquiring module 803, configured to in response to that the first event is an erroneous determination, take the video frame corresponding to the first event as a target video frame and acquire a frame identifier of the target video frame in the video frame sequence;

a reading module 804, configured to read the analysis result of the target video frame from a message queue based on the frame identifier, where the message queue is used to store an analysis result of each video frame in the video frame sequence; and

a pushing module 805, configured to push the analysis result of the target video frame.

In some examples, the apparatus further includes: a sending module, configured to send information of the first event to a displaying unit, so that the display unit displays the information of the first event.

In some examples, the information of the first event includes the frame identifier of the video frame corresponding to the first event in the video frame sequence.

In some examples, the first acquiring module includes: a first acquiring unit, configured to acquire the video frame sequence transmitted back by a remote terminal; and an analyzing unit, configured to obtain the analysis result of the video frame by analyzing the video frame in the video frame sequence.

In some examples, the first acquiring unit includes: a copying sub-unit, configured to copy the video frame sequence into a local test environment; and a switching sub-unit, configured to switch an input source of the video frame sequence to the video frame sequence copied into the local test environment.

In some examples, the first acquiring module includes: a second acquiring unit, configured to acquire text information carrying the analysis result of the video frame in the video frame sequence from the remote terminal, where the text information is generated by the remote terminal by analyzing the video frame in the video frame sequence.

In some examples, the analysis result of the video frame is issued to a preset message queue with a designated topic; the first acquiring module is configured to acquire the analysis result of the video frame by subscribing to the designated topic.

In some examples, the information of the first event includes the frame identifier of the video frame corresponding to the first event in the video frame sequence; the first acquiring module includes: a determining unit, configured to determine the topic corresponding to the analysis result of the target video frame according to the frame identifier of the target video frame in response to receiving an instruction for invoking the analysis result of the target video frame; and an extracting unit, configured to extract the analysis result of the target video frame from the message queue according to the topic corresponding to the analysis result of the target video frame.

In some examples, a number of video frames in the video frame sequence is greater than 1, and video frames in the video frame sequence are captured respectively by at least two video capture apparatuses with different views around a target region; the first acquiring module includes: a synchronization processing module, configured to perform synchronization for each single-view video frame in a plurality of single-view video frames captured respectively by the at least two video capture apparatuses; an initial analysis result acquiring module, configured to acquire an initial analysis result of each single-view video frame; and a fusing module, configured to obtain a analysis result of a plurality of synchronized single-view video frames by fusing the initial analysis results of the plurality of synchronized single-view video frames.

In some examples, the video frame sequence is obtained by performing video capture for the target region; the first acquiring module is configured to acquire the analysis result obtained by analyzing the video frame in the video frame sequence in a case that the remote terminal determines that an event unsatisfying a preset condition occurs in the target region.

In some examples, one or more other video frames spaced apart from the video frame corresponding to the first event by a number of frames smaller than a preset frame number in the video frame sequence are also taken as the target video frame.

In some examples, in a case that the first event is inconsistent with a second event determined by a user based on the video frame, the first event is determined as erroneous determination.

In some examples, the functions or modules of the apparatus according to an example of the present disclosure may be used to perform the methods described in the above method examples, and specific implementations thereof may be referred to descriptions of the above method examples, which will not be repeated herein for simplicity.

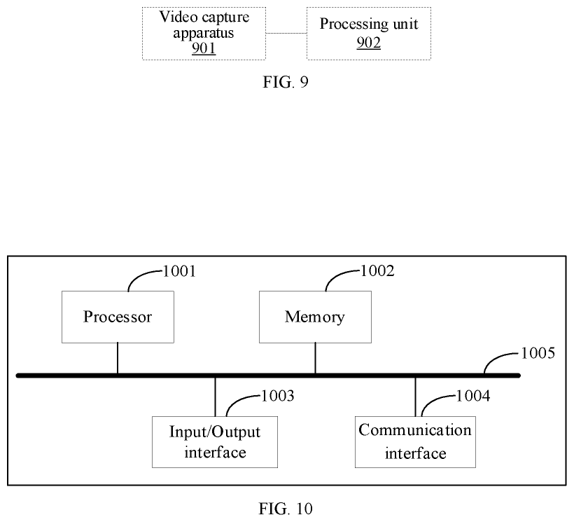

As shown in FIG. 9, the present disclosure further provides a system for processing data. The system includes:

a video capture apparatus 901 disposed around a target region to capture a video frame sequence of a target region; and

a processing unit 902 in communication with the video capture apparatus, configured to perform the method according to any example of the present disclosure.

An example of the present disclosure further provides a computer device. The computer device at least includes a memory, a processor and a computer program that is stored on the memory and executable on the processor. The computer program is executed by the processor to implement the method according to any example of the present disclosure described above.

FIG. 10 is a structural schematic diagram of a more specific computer device hardware according to an example of the present disclosure. The device may include a processor 1001, a memory 1002, an input/output interface 1003, a communication interface 1004 and a bus 1005. The processor 1001, the memory 1002, the input/output interface 1003 and the communication interface 1004 communicate with each other through the bus 1005 in the device.

The processor 1001 may be implemented by a general Central Processing Unit (CPU), a microprocessor, an Application Specific Integrated Circuit (ASIC) or one or more integrated circuits, and the like to execute relevant programs, so as to implement the technical solution according to the examples of the present disclosure. The processor 1001 may further include a graphics card, and the graphics card may be a Nvidia titan X graphics card, or a 1080Ti graphics card, or the like.

The memory 1002 may be implemented by a Read Only Memory (ROM), a Random Access Memory (RAM), a static storage device, a dynamic storage device, and the like. The memory 1002 may store an operating system and other application programs. When the technical solution according to an example of the present disclosure is implemented by software or firmware, relevant program codes are stored in the memory 1002, and invoked and executed by the processor 1001.

The input/output interface 1003 is configured to connect an inputting/outputting module so as to realize information input/output. The inputting/outputting module (not shown) may be configured as a component in the device, or may also be externally connected to the device to provide corresponding functions. The input device may include a keyboard, a mouse, a touch screen, a microphone, various sensors, and the like, and the output device may include a display, a speaker, a vibrator, an indicator light, and the like.

The communication interface 1004 is configured to connect a communicating module (not shown) so as to realize communication interaction between the device and other devices. The communicating module may realize communication in a wired manner (such as a USB and a network cable), or in a wireless manner (such as a mobile network, WIFI and Bluetooth).

The bus 1005 includes a passage for transmitting information between different components (such as the processor 1001, the memory 1002, the input/output interface 1003 and the communication interface 1004) of the device.

It is to be noted that although the above device only includes the processor 1001, the memory 1002, the input/output interface 1003, the communication interface 1004 and the bus 1005, the device may further include other components necessary for normal operation in a specific implementation process. In addition, persons skilled in the art may understand that the above device may further only include components necessary for implementation of the solution of an example of the present specification without including all components shown in the drawings.

An example of the present disclosure further provides a computer readable storage medium storing a computer program thereon. The program is executed by a processor to implement the method according to any example of the present disclosure described above.

The computer readable medium includes permanent, non-permanent, mobile and non-mobile media, which may realize information storage by any method or technology. The information may be computer readable instructions, data structures, program modules and other data. Examples of the computer storage medium include but not limited to: a phase change random access memory (PRAM), a Static Random Access Memory (SRAM), a Dynamic Random Access Memory (DRAM), and other types of RAMs, Read-Only Memories (ROM), Electrically-Erasable Programmable Read-Only Memories (EEPROM), Flash Memories or other memory technologies, CD-ROMs, digital versatile discs (DVD) or other optical storages, cassette type magnetic tapes, magnetic disk storages, or other magnetic storage devices or any other non-transmission mediums for storing information accessible by computing devices. According to the definition of the specification, the computer readable medium does not include transitory computer readable media, such as modulated data signals and carriers.

It may be known from descriptions of the above examples that persons skilled in the art may clearly understand that the examples of the present disclosure may be implemented by means of software and a necessary general hardware platform. Based on such understanding, the technical solutions of examples of the present disclosure essentially or a part contributing to the prior art may be embodied in the form of a software product, and the computer software product may be stored in a storage medium, such as a ROM/RAM, a diskette or a compact disk, and includes several instructions for enabling a computer device (such as a personal computer, a server or a network device) to perform the methods of different examples or some parts of the examples of the present disclosure.

The systems, apparatuses, modules or units described in the above examples may be specifically implemented by a computer chip or an entity, or may be implemented by a product with a particular function. A typical implementing device may be a computer, and the computer may specifically be a personal computer, a laptop computer, a cellular phone, a camera phone, a smart phone, a personal digital assistant, a media player, a navigation device, an email transceiver, a game console, a tablet computer, a wearable device, or a combination of any several devices of the above devices.

The examples in the present disclosure are described in a progressive manner, each example focuses on differences from other examples, and same or similar parts among the examples may be referred to each other. Especially, since apparatus examples are basically similar to method examples, simple descriptions are made to the apparatus examples, and relevant parts may be referred to part of the descriptions of the method examples. The apparatus examples described above are merely illustrative, where modules described as separate members may be or not be physically separated, and functions of different modules may be implemented in the same or several software and/or hardware during implementation of the examples of the present disclosure. Part or all of the modules may also be selected according to actual requirements to achieve the objectives of the solution of the example. Persons of ordinary skill in the art may understand and implement the solutions without creative work.

The above descriptions are merely specific examples of the present disclosure. It is to be noted that persons of ordinary skill in the art may also make several improvements and modifications without departing from the principles of the examples of the present disclosure, and these improvements and modifications shall also be included in the scope of protection of examples of the present disclosure.

1. A method of processing data, comprising:
acquiring an analysis result obtained by analyzing a video frame in a video frame sequence;
performing event determination for the analysis result of the video frame based on a pre-stored event determination logic, to determine a first event corresponding to the video frame;
in response to that the first event is an erroneous determination, taking the video frame corresponding to the first event as a target video frame and acquiring a frame identifier of the target video frame in the video frame sequence;
reading the analysis result of the target video frame from a message queue based on the frame identifier, wherein the message queue is used to store an analysis result of each video frame in the video frame sequence; and
pushing the analysis result of the target video frame.

2. The method according to claim 1, further comprising:
sending information of the first event to a displaying unit, so that the displaying unit displays the information of the first event.

3. The method according to claim 2, wherein the information of the first event comprises the frame identifier of the video frame corresponding to the first event in the video frame sequence.

4. The method according to claim 1, wherein acquiring the analysis result obtained by analyzing the video frame in the video frame sequence comprises:
acquiring the video frame sequence transmitted back by a remote terminal; and
obtaining the analysis result of the video frame by analyzing the video frame in the video frame sequence.

5. The method according to claim 4, wherein acquiring the video frame sequence transmitted back by the remote terminal comprises:
copying the video frame sequence into a local test environment; and
switching an input source of video frame sequence to the video frame sequence copied into the local test environment.

6. The method according to claim 1, wherein acquiring the analysis result obtained by analyzing the video frame in the video frame sequence comprises:
acquiring text information carrying the analysis result of the video frame in the video frame sequence from a remote terminal, wherein the text information is generated by the remote terminal analyzing the video frame in the video frame sequence.

7. The method according to claim 1, wherein the analysis result of the video frame is issued to a preset message queue with a designated topic; acquiring the analysis result obtained by analyzing the video frame in the video frame sequence comprises:
acquiring the analysis result of the video frame by subscribing to the designated topic.

8. The method according to claim 7, wherein the information of the first event comprises the frame identifier of the video frame corresponding to the first event in the video frame sequence; acquiring the analysis result of the video frame by subscribing to the designated topic comprises:
in response to receiving an instruction for invoking the analysis result of the target video frame, determining the topic corresponding to the analysis result of the target video frame according to the frame identifier of the target video frame; and
extracting the analysis result of the target video frame from the message queue according to the topic corresponding to the analysis result of the target video frame.

9. The method according to claim 1, wherein a number of video frames in the video frame sequence is greater than 1, and video frames in the video frame sequence are captured respectively by at least two video capture apparatuses with different views around a target region; acquiring the analysis result obtained by analyzing the video frame in the video frame sequence comprises:
performing synchronization for each single-view video frame in a plurality of single-view video frames captured respectively by the at least two video capture apparatuses;
acquiring an initial analysis result of each single-view video frame; and
obtaining an analysis result of a plurality of synchronized single-view video frames by fusing the initial analysis results of the plurality of synchronized single-view video frames.

10. The method according to claim 1, wherein the video frame sequence is obtained by performing video capture for a target region; acquiring the analysis result obtained by analyzing the video frame in the video frame sequence comprises:
acquiring the analysis result obtained by analyzing the video frame in the video frame sequence in a case that a remote terminal determines that an event unsatisfying a preset condition occurs in the target region.

11. The method according to claim 1, wherein one or more other video frames spaced apart from the video frame corresponding to the first event by a number of frames smaller than a preset frame number in the video frame sequence are also taken as the target video frame.

12. The method according to claim 1, wherein in a case that the first event is inconsistent with a second event determined by a user based on the video frame, the first event is determined as erroneous determination.

13. A system for processing data, comprising:
a video capture apparatus disposed around a target region to capture a video frame sequence of the target region; and
a processing unit in communication with the video capture apparatus, configured to perform operations for processing data, the operations comprising:
acquiring an analysis result obtained by analyzing a video frame in a video frame sequence;
performing event determination for the analysis result of the video frame based on a pre-stored event determination logic, to determine a first event corresponding to the video frame;
in response to that the first event is an erroneous determination, taking the video frame corresponding to the first event as a target video frame and acquiring a frame identifier of the target video frame in the video frame sequence;
reading the analysis result of the target video frame from a message queue based on the frame identifier, wherein the message queue is used to store an analysis result of each video frame in the video frame sequence; and
pushing the analysis result of the target video frame.

14. A computer device comprising a memory, a processor and a computer program that is stored on the memory and operable on the processor, wherein the program is executed by the processor to implement operations for processing data, the operations comprising:
acquiring an analysis result obtained by analyzing a video frame in a video frame sequence;
performing event determination for the analysis result of the video frame based on a pre-stored event determination logic, to determine a first event corresponding to the video frame;
in response to that the first event is an erroneous determination, taking the video frame corresponding to the first event as a target video frame and acquiring a frame identifier of the target video frame in the video frame sequence;
reading the analysis result of the target video frame from a message queue based on the frame identifier, wherein the message queue is used to store an analysis result of each video frame in the video frame sequence; and
pushing the analysis result of the target video frame.
